(19) United States
(12) Patent Application Publication
(10) Pub. No.: US 2015/0042850 A1
(43) Pub. Date: Feb. 12, 2015

(54) Apparatus and a Method for Imaging

(71) Applicants: Radu Bilcu, Tampere (FI); Martin Schrader, Tampere (FI)

(72) Inventors: Radu Bilcu, Tampere (FI); Martin Schrader, Tampere (FI)

(73) Assignee: Nokia Corporation, Espoo (FI)

(21) Appl. No.: 14/386,409

(22) PCT Filed: Mar. 20, 2012
(86) PCT No.: PCT/FI2012/050265

§ 371 Date: Sep. 19, 2014

(51) Int. Cl. H04N 9/097

(52) U.S. Cl. CPC H04N 9/097; G02B 27/4205
USPC 348/253

(57) ABSTRACT

An apparatus and a method is provided. An apparatus including at least one color separation diffraction grating configured to direct different spectral components of incident light in different directions; one or more further diffraction gratings configured to at least partially compensate for dispersion in one or more of the different spectral components of light; and one or more image sensors configured to detect the one or more dispersion compensated spectral components of light.

### TECHNOLOGICAL FIELD

Embodiments of the present invention relate to imaging. In particular, they relate to imaging using a color separation diffraction grating.

### BACKGROUND

Many image sensors have light sensitive pixels for sensing red, green and blue light arranged in a Bayer pattern array. Each pixel has a filter which allows one of red, green or blue light to pass. The Bayer pattern array is advantageous in that it enables small image sensors for sensing red, green and blue to be manufactured. However, the Bayer pattern array has several disadvantages, including the following:
it is difficult to produce very small color filters that only allow light of a particular color to pass;
light sensitivity between the red, green and blue pixels tends to vary;
having pixels for sensing different colors close to one another tends to result in color leakage (for example where the electric charge of a pixel for sensing a first color influences the electric charge of an adjacent pixel for sensing a second color);
in many implementations, the exposure time and analog gain have to be the same for all pixels in a sensor; and
the resolution of the raw image captured is less than “full resolution” since there is only one pixel for sensing one color at a particular location. Missing color components must be obtained using pixel interpolation.

### BRIEF SUMMARY

According to various, but not necessarily all, embodiments of the invention there is provided an apparatus, comprising: at least one color separation diffraction grating configured to direct different spectral components of incident light in different directions; one or more further diffraction gratings configured to at least partially compensate for dispersion in one or more of the different spectral components of light; and one or more image sensors configured to detect the one or more dispersion compensated spectral components of light.

According to various, but not necessarily all, embodiments of the invention there is provided a method, comprising: diffracting different spectral components of incident light in different directions; at least partially compensating for dispersion in one or more of the different spectral components of light; and detecting the one or more dispersion compensated spectral components of light.

According to various, but not necessarily all, embodiments of the invention there is provided an apparatus, comprising: means for diffracting different spectral components of incident light in different directions; means for at least partially compensating for dispersion in one or more of the different spectral components of light; and means for detecting the one or more dispersion compensated spectral components of light.

### BRIEF DESCRIPTION

For a better understanding of various examples of embodiments of the present invention, reference will now be made by way of example only to the accompanying drawings in which:

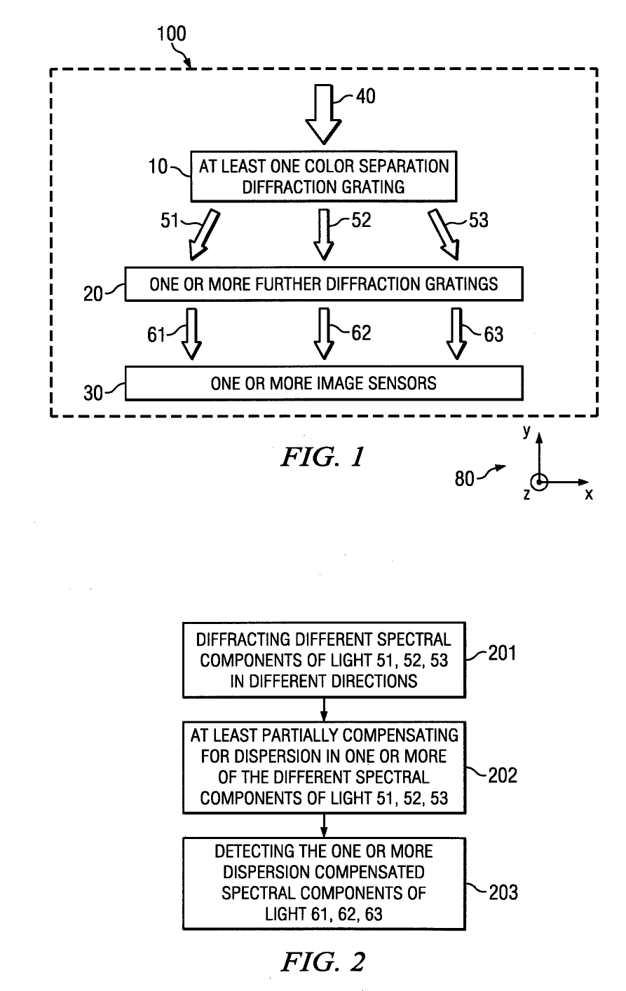

FIG. 1 illustrates a functional schematic of an apparatus;

FIG. 2 illustrates a flow chart of a method;

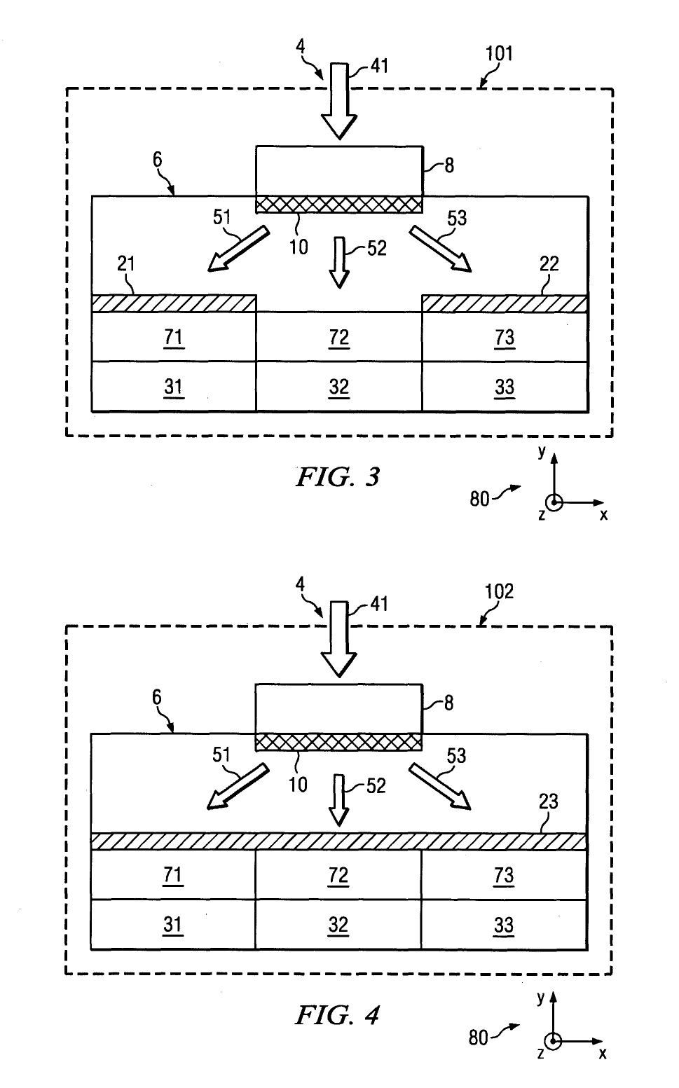

FIG. 3 illustrates a first implementation of the apparatus; and

FIG. 4 illustrates a second implementation of the apparatus.

### DETAILED DESCRIPTION

Embodiments of the invention relate to using at least one color separation diffraction grating to separately image different parts of the color spectrum and compensate for dispersion.

In this regard, the figures illustrate an apparatus 100/101/102, comprising: at least one color separation diffraction grating 10 configured to direct different spectral components 51-53 of incident light 40 in different directions; one or more further diffraction gratings 20-23 configured to at least partially compensate for dispersion in one or more of the different spectral components 51-53 of light; and one or more image sensors 30-33 configured to detect the one or more dispersion compensated spectral components 61-63 of light.

FIG. 1 illustrates a functional schematic of an apparatus 100. The apparatus 100 may, for example, be the whole or part of any of the following: a mobile telephone, a personal computer, a tablet computer, a personal digital assistant and/or a games console.

The apparatus 100 illustrated in FIG. 1 comprises at least one color separation diffraction grating 10, one or more further diffraction gratings 20 and one or more image sensors 30. The elements 10, 20, 30 are operationally coupled and any number or combination of intervening elements can exist (including no intervening elements).

The at least one color separation diffraction grating 10 is configured to direct different spectral components of incident light 51-53 in different directions. The at least one color separation diffraction grating 10 may, for example, be provided on a face/surface of a body such as a plate.

The one or more further diffraction gratings 20 are configured to at least partially compensate for dispersion in one or more of the different spectral components of light 51-53. In some implementations, the one or more further diffraction gratings 20 may consist of a further color separation diffraction grating. In other implementations, the one or more further diffraction gratings 20 may be or comprise one or more blazed gratings and/or one or more slanted gratings.

The one or more further diffraction gratings 20 may, for example, be provided on a different face/surface of the body/plate mentioned above. The body may have a length, width and thickness, where the length is the same as or greater than the width, and where the thickness is smaller than the length and the width. The face/surface on which the one or more further diffraction gratings 20 are provided may be separated from the face/surface on which the at least one color separation diffraction grating 10 is provided by the thickness of the body. The at least one color separation diffraction grating 10 may be at least one in-coupling grating of the body and the one or more further diffraction gratings 20 may be one or more out-coupling gratings of the body.

The one or more image sensors 30 may be any type of image sensors. They are configured to detect the one or more dispersion compensated spectral components 61-63 of light. Each image sensor may or may not comprise a different color filter.

A method according to embodiments of the invention will now be described in relation to FIGS. 1 and 2.

FIG. 1 illustrates incident light 40 that has entered the apparatus 100 via an aperture of the apparatus 100. The incident light 40 has emanated from a particular scene/image capture region and travelled through the aperture of the apparatus 100. The light 40 includes spectral components of a variety of colors.

At block 201 in FIG. 2, the at least one color separation diffraction grating 10 diffracts different spectral components 51-53 of the incident light 40 into different directions. In this example, a single color separation diffraction grating 10 is used to diffract three different spectral components 51-53 of light into three separate directions. The arrows 51-53 in FIG. 1 illustrate the propagation direction of each of the spectral components.

A first spectral component 52 of the incident light 40 (for example, a green component of the light 40) is directed to a zeroth order and, as such, its propagation direction is substantially unaffected by the color separation diffraction grating 10.

A second spectral component 51 of the incident light 40 (for example, a red component of the light 40) is directed by the color separation diffraction grating 10 to a negative first order, and, in doing so, the propagation direction of the second spectral component 51 is changed in at least one dimension. A set of Cartesian co-ordinate axes 80 is illustrated in FIG. 1. In the illustrated example, the propagation direction of the second spectral component 51 is changed by the color separation diffraction grating 10 in the x-dimension.

A third spectral component 53 of the incident light 40 (for example, a blue component of the light 40) is directed by the color separation diffraction grating 10 to a positive first order, and, in doing so, the propagation direction of the third spectral component 53 is changed in at least one dimension. In the illustrated example, the propagation direction of the third spectral component 53 in the x-dimension is changed by the color separation diffraction grating 10.

The color separation diffraction grating 10 is configured to spatially divide the incident light 40 into multiple different spectral components of light at particular, defined wavelengths. Light which has a wavelength that is (slightly) different from one of these “defined wavelengths” will be diffracted in a (slightly) different manner by the color separation diffraction grating 10, causing dispersion in one or more of the diffracted spectral components 51-53 (and potentially resulting in poor image quality).

At block 202 in FIG. 2, the one or more further diffraction gratings 20 at least partially compensate for dispersion in one, some or all of the spectral components 51-53 of light by diffracting one, some or all of the spectral components 51-53 of light. The dispersion compensated spectral components of light are illustrated in FIG. 1 as arrows 61, 62 and 63.

Dispersion compensation is achieved by using the one or more further diffraction gratings 20 to reverse any changes in propagation direction that were introduced by the at least one color separation diffraction grating 10. For instance, in this example, the one or more further diffraction gratings 20 change the propagation direction of the second and third spectral components 51, 53 in the x-dimension such that, after the change has occurred, they propagate in the same direction as the light 40 incident upon the color separation diffraction grating 10.

In order to achieve this effect, the one or more further diffraction gratings 20 have the same grating period (that is, the same grating density) as the at least one color separation diffraction grating 10.

In the example illustrated in FIG. 1, the one or more further diffraction gratings 20 diffract the second (red) spectral component 51 of light to a positive first order and diffract the third (blue) spectral component of light to a negative first order (each of these is the opposite diffraction order to the diffraction order for each spectral component of light that is defined by the at least one color separation diffraction grating 10).

At block 203 in FIG. 2, the one or more image sensors 30 detect the one or dispersion compensated spectral components 61-63 of light. In some embodiments of the invention, a different image sensor is provided for each of the different dispersion compensated spectral components 61-63 of light. Alternatively, in other embodiments of the invention, different portions of a single image sensor may be used to detect each of the different dispersion compensated spectral components 61-63 of light.

The information detected by each image sensor/image sensor portion may then be combined to form an image. Advantageously, since each of the dispersion compensated spectral components 61-63 of light consists of light which originates from the same scene/image capture region, there is no need to perform complex processing to align the images captured by each image sensor/image sensor region when combining the images.

Use of at least one color separation diffraction grating 10 to spatially separate different spectral components of light from one another is also advantageous, because it enables each different spectral component of light to be detected by a separate image sensor/sensor region that consists of pixels specifically for detecting light of that spectral band. This, in turn, results in less “color leakage” due to better separation of pixels used for detecting different colors and also makes fabrication of the image sensors/image sensor regions easier (because there is no need for the alternating color filters used in a Bayer pattern array).

Furthermore, use of separate image sensors/sensor regions for different spectral components advantageously enables an image sensor for a spectral band to be selected which is particularly sensitive in that spectral band.

FIG. 3 illustrates a first implementation 101 of the apparatus 100 illustrated in the functional schematic of FIG. 1. The apparatus 101 illustrated in FIG. 3 comprises an aperture 4, a plurality of image sensors 31, 32, 33, “object side” optics 8, “image side” optics 71, 72, 73, and a body 6 having a first face with at least one color separation diffraction grating 101 thereon, and a second face with a plurality of further diffraction gratings 21, 22 thereon. The at least one color separation diffraction grating 101 is an in-coupling grating of the body 6, and the diffraction gratings 21, 22 are out-coupling gratings of the body 6.

The “object side” optics 8 and each of the “image side” optics 71, 72, 73 may be or comprise one or more optical devices, such as one or more lenses.

FIG. 3 illustrates light 41 entering the apparatus via the aperture 4. In this implementation, the object side optics 8 is configured to collimate light rays 41 emanating from an object, causing a parallel light beam to enter the color separation diffraction grating 10 for each point on the object. Each parallel light beam is incident upon the color separation diffraction grating 10 with a particular input/field angle.

The color separation diffraction grating 10 diffracts each parallel light beam, causing the different spectral components of light to be directed in different directions, as illustrated by the arrows 51-53 in FIG. 3.

In this example, a first spectral component 52 of light directed to the zeroth order (which may, for example, be green light), is not diffracted further before being focused onto a first image sensor 32 by first image side optics 72.

First and second blazed or slanted diffraction gratings 21, 22 diffract the second and third spectral components 51, 53 of light respectively (which may, for example, be red and blue light respectively), at least partially compensating for dispersion in the second and third spectral components 51, 53.

The diffraction gratings 21, 22 reverse any changes in propagation direction that were introduced by the color separation diffraction grating 10, as described above in relation to FIG. 1. In this example, as in the FIG. 1 example, the diffraction gratings 21, 22 change the propagation direction of the second and third spectral components 51, 53 in the x-dimension such that, after the change has occurred, they propagate in the same direction as the collimated light incident upon the color separation diffraction grating 10. This means that light emanating from a particular point on an object being imaged has the same input/field angle when it enters the image side optics 71, 73 as it did when entering object side optics 8, resulting in an accurate optical image being formed on each image sensor 31-33.

Each image sensor 31, 32, 33 detects an image having the color of the dispersion compensated spectral component of light directed towards it. Each image sensor 31, 32, 33 may have a differently colored filter. However, since the color separation diffraction grating 10 separates light into different spectral components, there is no need for the image sensors 31, 32, 33 to have such color filters.

The images formed by the image sensors 31, 32, 33 may be combined to form a full color image.

FIG. 4 illustrates a second implementation 102 of the apparatus 100 illustrated in the functional schematic of FIG. 1. The second implementation 102 differs from the first implementation 101 in that the “one or more further diffraction gratings 20” consists of a second color separation diffraction grating 23 rather than first and second blazed/slanted gratings 21, 22.

In this implementation, the second color separation grating 23 may be the same as the first color separation grating 10 but orientated differently, such that it causes the opposite change in the propagation direction of the second and third spectral components 51, 53 of light to that caused by the first color separation grating 10.

The illustration of a particular order to the blocks in FIG. 2 does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

For example, in some embodiments, the body 6 may be used as a light guide, inside which light is internally reflected. Each of the image sensors 31-33 may have the same resolution or different resolutions. Different settings may be applied to images captured by each of the image sensors 31-33. The “image side” optics 71, 72, 73 may be controlled synchronously or separately.

In the examples described above, the second and third spectral components 51, 53 of light are directed by the color separation diffraction grating 10 to negative and positive first orders. In other examples, however, one or both of the second and third spectral components 51, 53 of light may be directed to higher orders. In such examples, the one or more further diffraction gratings 20 direct the second and third spectral components 51, 53 of light to the opposite higher diffraction orders to the color separation diffraction grating 10.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus, comprising:
at least one color separation diffraction grating configured to direct different spectral components of incident light in different directions;
one or more further diffraction gratings configured to at least partially compensate for dispersion in one or more of the different spectral components of light; and
one or more image sensors configured to detect the one or more dispersion compensated spectral components of light.

2. An apparatus as claimed in claim 1, wherein the at least one color separation diffraction grating is configured to change the propagation direction of at least one spectral component of light in at least a first dimension, and the one or more further diffraction gratings is configured to revert the at least one spectral component of light back to its propagation direction before the change.

3. An apparatus as claimed in claim 1, wherein the at least one color separation diffraction grating is configured to diffract different spectral components of incident light to different diffraction orders.

4. An apparatus as claimed in claim 3, wherein the at least one color separation diffraction grating is configured to diffract a particular spectral component of light to a particular diffraction order, and the one or more further diffraction gratings are configured to diffract the particular spectral component of light to a diffraction order that is opposite to the particular diffraction order.

5. An apparatus as claimed in claim 1, wherein the at least one color separation diffraction grating is configured to direct a first spectral component of light to a zeroth order, a second spectral component of light to a positive first order and a third spectral component of light to a negative first order.

6. An apparatus as claimed in claim 5, wherein the one or more further diffraction gratings are configured to direct the second spectral component of light to a negative first order and the third spectral component of light to a positive first order.

7. An apparatus as claimed in claim 1, wherein each dispersion compensated spectral component of light consists of light from the same image capture region.

8. An apparatus as claimed in claim 1, wherein the at least one color separation diffraction grating is at least one in-coupling grating of a body and at least one of the one or more further diffraction gratings is an out-coupling grating of the body.

9. An apparatus as claimed in claim 8, wherein the body is a light guide configured to cause at least one spectral component of light to reflect internally within the body.

10. An apparatus as claimed in claim 1, wherein the one or more further diffraction gratings consists of a single color separation diffraction grating.

11. An apparatus as claimed in claim 1, wherein the one or more further diffraction gratings comprise one or more blazed gratings and/or one or more slanted gratings.

12. An apparatus as claimed in claim 1, further comprising optics configured to collimate light towards the at least one color separation diffraction grating.

13. An apparatus as claimed in claim 1, wherein the one or more image sensors is a plurality of image sensors.

14. An apparatus as claimed in claim 13, further comprising: optics configured to focus light onto each image sensor.

15. An apparatus as claimed in claim 13, wherein at least two image sensors are positioned to detect at least two different dispersion compensated spectral components of light.

16. An electronic device comprising a display and the apparatus as claimed in claim 1.

17. A method, comprising:
diffracting different spectral components of incident light in different directions;
at least partially compensating for dispersion in one or more of the different spectral components of light; and
detecting the one or more dispersion compensated spectral components of light.

18. A method as claimed in claim 17, wherein different spectral components of incident light are diffracted to different diffraction orders.

19. An apparatus as claimed in claim 18, wherein a particular spectral component of light is diffracted to a particular diffraction order, and subsequently the particular spectral component of light is diffracted to a diffraction order that is opposite to the particular diffraction order.

20. A method as claimed in claim 17, wherein at least one color separation diffraction grating is used to diffract the different spectral components of incident light in different directions.

21. A method as claimed in claim 20, wherein the at least one color separation diffraction grating is configured to change the propagation direction of at least one spectral component of light in at least a first dimension.

22. A method as claimed in claim 20, wherein the at least one color separation diffraction grating is configured to direct a first spectral component of light to a zeroth order, a second spectral component of light to a positive first order, and a third spectral component of light to a negative first order.

23. A method as claimed in claim 17, wherein one or more further diffraction gratings is used to at least partially compensate for dispersion in one or more of the different spectral components of light.

24. A method as claimed in claim 23, wherein the one or more further diffraction gratings changes the propagation direction of at least one spectral component of light.

25. A method as claimed in claim 23, wherein the one or more further diffraction gratings consists of a single color separation diffraction grating.

26. A method as claimed in claim 23, wherein the one or more further diffraction gratings comprise one or more blazed gratings and/or one or more slanted gratings.

27. A method as claimed in claim 17, wherein each dispersion compensated spectral component of light consists of light from the same image capture region.

28. A method as claimed in claim 17, wherein the one or more dispersion compensated spectral components of light are detected by one or more image sensors.

29. A method as claimed in claim 28, wherein the one or more image sensors is a plurality of image sensors.

30. A method as claimed in claim 29, wherein at least two image sensors are positioned to detect at least two different dispersion compensated spectral components of light.

31. An apparatus comprising means for performing the method as claimed in claim 17.

32. An apparatus, comprising:
means for diffracting different spectral components of incident light in different directions; means for at least partially compensating for dispersion in one or more of the different spectral components of light; and
means for detecting the one or more dispersion compensated spectral components of light.

33. An apparatus as claimed in claim 32, wherein the means for diffracting different spectral components of incident light in different directions is at least one color separation diffraction grating, the means for at least partially compensating for dispersion in one or more of the different spectral components of light is one or more further diffraction gratings; and the means for detecting the one or more dispersion compensated spectral components of light is one or more image sensors.
